(19) United States
(12) Patent Application Publication
(10) Pub. No.: US 2013/0054447 A1
(43) Pub. Date: Feb. 28, 2013

(54) SYSTEM TO IDENTIFY RISK BASED ON NETWORK POSITION

(71) Applicants: Erik Stephen Ross, Charlotte, NC (US); Katherine Ann Krumme, San Francisco, CA (US)

(72) Inventors: Erik Stephen Ross, Charlotte, NC (US); Katherine Ann Krumme, San Francisco, CA (US)

(73) Assignee: Bank of America Corporation, Charlotte, NC (US)

(21) Appl. No.: 13/217,913

(22) Filed: Aug. 25, 2011

(51) Int. Cl. G06Q 40/00

(52) U.S. Cl. 705/38

(57) ABSTRACT

Embodiments of the invention relate to systems, methods, and computer program products for determining a customer's risk profile by collecting data, via a computing processor, relating to the customer's risk tendencies from social networks which the customer is a member and from customer data available to a merchant based on prior dealings with the customer, analyzing the two sets of customer data with the computing processor to correlate the data to indicators of increased risk and determining a customer risk profile based on the indicators of increased risk.

### FIELD

In general, embodiments of the invention relate to methods, systems, apparatus and computer program products for determining a customer's risk profile based on an analysis of the customer's social network data and the data available to a merchant based on prior interactions with the customer.

### BACKGROUND

There is some level of risk inherent in every type of business and commercial activity. In this context, a risk can be defined as an event, situation or condition that may occur and if it occurs, will impact the ability of a business to achieve its desired objectives. To be successful, a business must create systems that enable it to successfully identify situations or customers that represent a risk to the business.

Traditional systems for assessing risk generally rely on information related solely to an individual's personal actions (e.g. an individual previously defaulted on a loan and is deemed not a good credit risk, an individual who has accumulated high, unpaid amounts of credit may be deemed unfit for a long-term installment contract, and individual who smokes may not be a good insurance risk etc.) but have not assessed the risk associated with entering a transaction or commercial relationship with an individual based on his or her association with others and considered the extent to which these other people's risk tendencies may reflect or influence the individual's risk profile.

Recent years have seen a vast expansion of the use of social networks to connect individuals, access information and communicate with groups of people that share similar backgrounds, interests or characteristics. The rise of social networks presents an opportunity for businesses to both identify information about their customers and potential customers as well as information about the people or entities with which the customer/potential customer associates, in order to help assess the customer's risk tendencies.

Therefore, a need exists for a system that can collect and analyze data regarding a customer's risk tendencies from social network data, including information regarding the customer's social network position and the risk tendencies of her connections, as well as other available data to determine the customer's risk profile.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Some embodiments of the present invention provide a method for determining a customer's risk profile, wherein a computing processor collects a first set of customer data that is indicative of the customer's risk tendencies from social networks in which the customer is member. The computing processor also collects an additional set of customer data, this second set of customer data being information that is available to a merchant based on prior interactions between the merchant and the customer. The computing processor analyzes both the social network data and the second set of customer data in order to correlate the data to indicators of increased risk. A customer risk profile is then determined based on the indicators of increased risk identified by the computing processor.

In some embodiments, the first set of customer data comprises the customer's social network position. In some embodiments, the second set of customer data comprises transactional data. In other embodiments, the second set of customer data comprises account history data. In yet other embodiments, the second set of customer data comprises biographical data.

In certain embodiments of the invention, analyzing the first set of customer data involves creating a hierarchy of influence, wherein the levels of connections between two or more of the connections in the customer's social network are compared, and those connections in the customer's social network with a conspicuous risk profile are identified. In some embodiments, analyzing the first set of customer data includes gauging the interval of time between incidents in the first set of customer data and the present time. In some embodiments, analyzing the second set of customer data includes gauging the interval of time between incidents in the second set of customer data and the present time.

In some embodiments, the customer's risk profile is used in the decision to offer products or services to the customer and in some embodiments, the risk being considered is the customer's risk of defaulting on a financial obligation.

In one embodiment an apparatus is provided for determining a customer's risk profile, wherein the apparatus features a computing platform including a memory and at least one processor. Stored in the memory and executable by the processor is a first customer data collection application that is configured to collect a first set of customer data that is indicative of the customer's risk tendencies and is taken from social networks in which the customer is a member. Also stored in the memory and executable by the processor is a second customer data collection application. The second customer data collection application is configured to collect a second set of customer data, which includes data available to a merchant based on prior interactions between the merchant and the customer. A data analysis routine is also stored in the memory and executable by the processor, which is configured to analyze the first and second set of customer data in order to correlate the data to indicators of increased risk. A customer risk profile application, which is stored in the memory and executable by the processor determines a customer risk profile based on the indicators of increased risk.

In some embodiments the first set of customer data collected by the first customer data collection application includes the customer's social network position. In certain embodiments the second set of customer data, which is collected by the second customer data collection application, is transactional data. In other embodiments, the second set of customer data includes account history data. In still further embodiments, the second set of customer data collected by the second customer data collection application is biographical data.

In certain embodiments the data analysis routine, in analyzing the first set of customer data, will create a hierarchy of influence, wherein the levels of connections between two or more of the connections in the customer's social network are compared and identify those connections in the customer's social network with a conspicuous risk profile. In some embodiments, the data analysis routine will gauge the interval of time between incidents within the first set of customer data and the present time. In some embodiments, the data analysis routine will gauge the interval of time between incidents within the second set of customer data and the present time.

In some embodiments the apparatus will feature a decision application, stored in the memory, executable by the processor and configured to use the customer's risk profile in the decision to offer products or services to the customer. In some embodiments the risk being considered by the apparatus is the risk of the customer defaulting on a financial obligation.

Some other embodiments of the present invention provide a computer program product including a computer-readable medium comprising a first set of code for causing a computer to collect customer data that is indicative of the customer's risk tendencies taken from social networks in which the customer is a member. A second set of code is also provided for, for causing a computer to collect a second set of customer data, wherein the second set of customer data comprises data available to a merchant based on prior interactions between the merchant and the customer. In this embodiment, the computer-readable medium also includes a third set of code for causing a computer to analyze the first and second set of customer data in order to correlate the data to indicators of increased risk. There is also a fourth set of code for causing a computer to determine a customer risk profile based on the indicators of increased risk.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a process flow for an apparatus for determining a customer's risk profile, in accordance with embodiments of the invention.

FIG. 2 is a flow diagram illustrating a process flow for an apparatus for collecting sets of data relating to the customer's risk tendencies, in accordance with embodiments of the invention.

FIG. 3 is a mixed block and flow diagram illustrating an apparatus for analyzing collected customer data, in accordance with embodiments of the invention.

FIG. 4 is a. block diagram illustrating an apparatus, in accordance with embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Although embodiments of the present invention described herein are generally described as involving a merchant or business, it will be understood that this may involve one or more persons, organizations, businesses, institutions and/or other entities such as financial institutions, services providers etc. that implement one or more portions of one or more of the embodiments described and/or contemplated herein.

It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, etc. The social network may be a network unique to the invention or may incorporate already-existing social networks such as Facebook®, Twitter®, Linkedin®, YouTube® as well as any one or more existing web logs or “blogs,” forums and other social spaces.

It will be further understood that “connection” or “connections” as used herein in the context of a social network refers to one or more members of an individuals' social network. For example, a person's family members or friends may be considered individually as a connection within the person's social network, or collectively as the person's connections.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, apparatus, systems, methods and computer program products are herein disclosed for determining a customer's risk profile based on an analysis of the customer's social network data and the data available to a merchant based on prior interactions with the customer. Embodiments of the present invention will leverage the information available to a merchant to identify data that is indicative of a customer's risk tendencies. Such data may include, but is not limited to the customer's personal actions, including but not limited to, prior default, bankruptcy, breach of term contract, high revolving debt, sudden changes in credit behavior etc. The customer data considered by the present invention may also include the risk tendencies of those people and organizations with whom the customer associates, i.e. the customer's social network connections. Embodiments of the present invention leverage the fact that social networks are a grouping of individuals or organizations based on commonalities between the individual and his or her connections. Accordingly, individuals in similar economic and life circumstances, with similar risk profiles may be connected within a social network. Thus, information about a customer's connections may suggest information about the customer. Moreover, connections within a social network may be in a position to influence a customer's decision making processes and so trends within an individual's social network may trickle down to the customer. For instance, and without limitation, if a customer's friends all appear to engage in similar activities that may represent increased health risks, such as smoking, riding motorcycles etc. inasmuch as the customer has chosen to associate with these people, it may be indicative that the customer also engages in these activities and may be an increased risk for health insurance. For another example, if an economic downturn is beginning to affect a discrete geographical region, evidence of this downturn may first appear in the risk behaviors of a customer's friends who live the same area, and so, if a customer's local friends begin to default on their credit obligations, it may indicate that the customer will soon have trouble meeting his credit obligations despite other data indicating the customer normally has a low risk profile. Similarly, if a customer has a number of connections within her social network that have recently filed for bankruptcy, these connections' experiences may inform and influence the customer and remove any perceived stigma associated with filing for bankruptcy. Thereafter, the customer may be at an increased risk of also filing for bankruptcy despite the customer's personal actions indicating that the customer represents a low risk. Inasmuch as financial institutions routinely must assess a customer's risk before offering products or services to the customer, specific embodiments disclosed herein relate to a financial institution utilizing a customer's social network data and other customer data to determine a customer risk profile for use in connection with deciding whether to offer financial products or services to the customer.

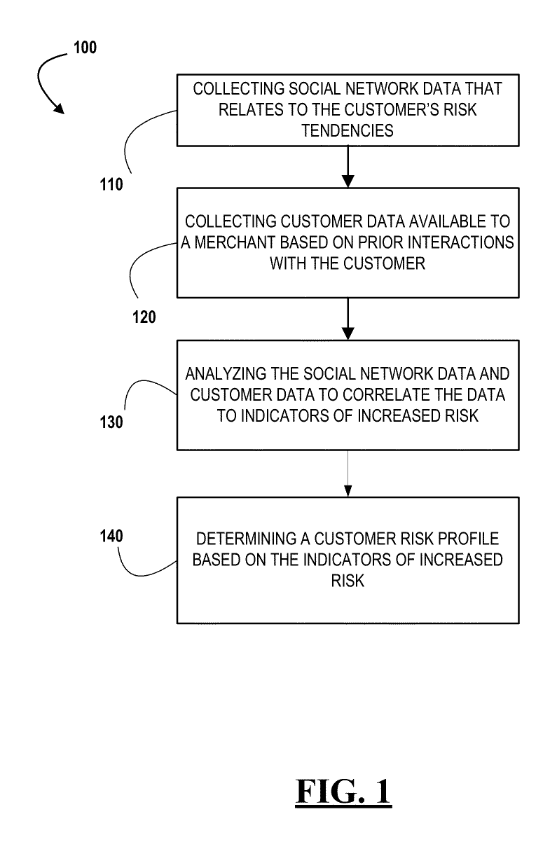

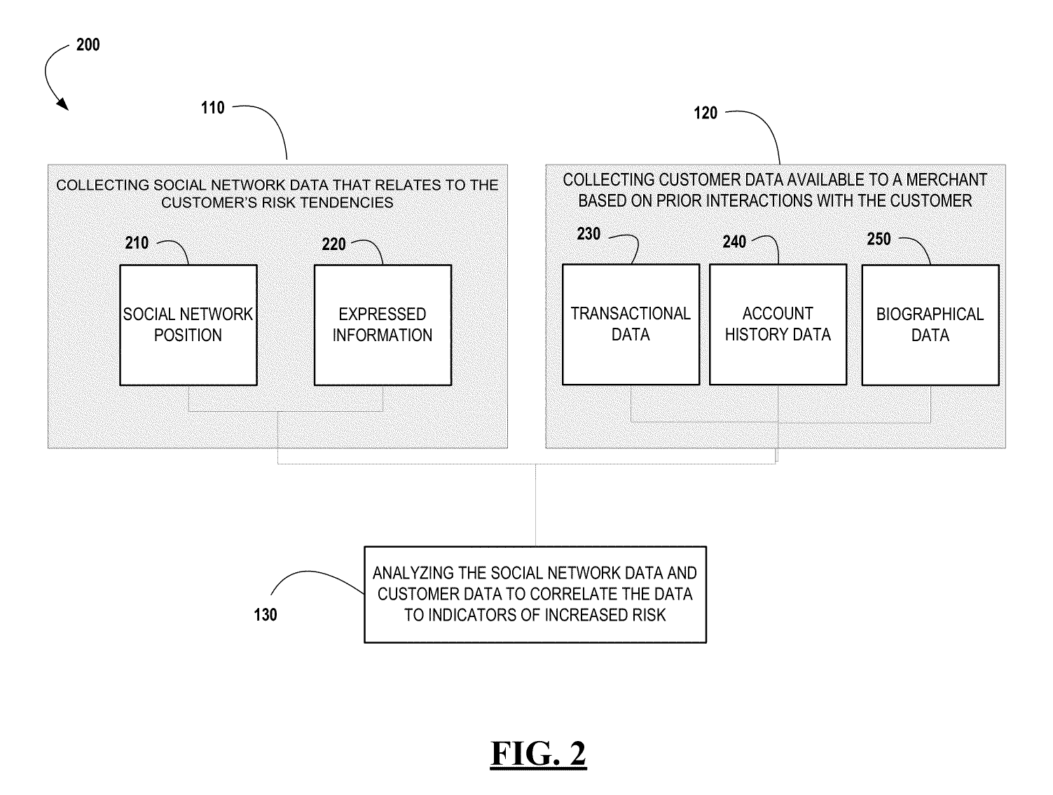

FIG. 1 illustrates a general process flow 100 for determining a customer's risk profile, in accordance with an embodiment of the present invention. As represented by block 110 a first set of customer data is collected, for example using a computing processor, wherein the first set of data is social network data that relates to the customer's risk tendencies. As represented by block 120, a second set of customer data is also collected, in some embodiments by the computing processor, wherein the second set of customer data is customer data that is available to the merchant (e.g. retailer, financial institution, service provider etc.) based on prior interactions with the customer. Both sets of data are analyzed, as represented by block 130, to correlate the first and second set of customer data to indicators of increased risk. As represented by block 140 a customer risk profile is determined based on the indicators of increased risk. It will be understood that in certain embodiments, determining a customer risk profile based on the first and second sets of data is done dynamically so that the customer's risk profile is constantly updated as new data becomes available to provide a real-time view of the customer's risk profile. Embodiments of the process flow 100, and systems for performing the process flow 100, are described in greater detail below with reference to FIGS. 2-4.

FIG. 2 provides a flow diagram 200 illustrating a general process flow of an apparatus or system for collecting a first set of data from a customer's social network data 110 and a second set of data from available customer data 120. The process flow, represented by block 110 of collecting social network data that relates to the customer's risk tendencies may include collecting information regarding the customer's social network position, represented by block 210, and collecting expressed information from the customer's social network, block 220. The customer's social network position includes any information relating to the identity of the customer's connections, the nature and degree of connection between the customer and his or her connections and the risk tendencies of the customer's connections. For instance, a customer's social network data may indicate that the individual has a number of connections with whom he regularly interacts (i.e. electronic communications, postings, comments etc.) and some connections with whom he interacts little. Information regarding the customer's connections may be available from publicly available profiles, information uploaded to the social network, comments made to the customer etc. All of this information defines the customer's social network position and provides information about how these connections may affect the customer's risk tendencies. By way of example, if a customer's best friend demonstrates a high level of risk activity, this may be more likely to affect the customer's risk profile than if an old high school classmate, with whom the customer rarely, if ever interacts, demonstrates a high level of risk activity.

As noted, collecting social network data that relates to the customer's risk tendencies may also include collecting expressed information, as represented by block 220. Expressed information includes any information or data that is disclosed by the customer or her connections within the social network. Expressed information includes, but is not limited to, postings, comments, profile information, blog entries, micro-blog entries, updates, communications, photos, chat entries etc. Such information may relate to the customer's personal actions or may include information regarding the customer's connections' actions. By way of example, if a customer creates a blog entry describing his financial troubles and expressing his doubts that he will be able to fulfill his current financial obligations, such information will directly relate to the customer's risk tendencies and reflect a potential increased risk. Similarly, if a close friend of the customer posts a comment on the wall of the customer's Facebook® account indicating the friend is sorry to hear that he just lost his job, this to may be indicative that the customer may represent an increased risk. Another example of expressed information may include a close friend or family member's tweets from a Twitter® account that the customer follows wherein the connection boasts of exhausting his or her credit limits and includes pictures of recent purchases. This connection's high risk behavior may, by association, be a reflection of the customer's own tendencies or may represent a risk of the connection negatively influencing the customer to adopt higher risk behaviors.

The second set of data being collected by the system or apparatus, as illustrated by block 120, may include the customer's transactional data, represented by block 230. Transactional data includes, but is not limited to, data regarding the date, location, amount, method of payment etc. of the transactions of the customer. Transactional data can be information relating to a present transaction (i.e. the purchase of a car) or can be historical data relating to previous purchases. The second set of customer data may also include the customer's account history data, as illustrated by block 240. Account history data includes, without limitation, such data as the types of accounts the customer has (e.g. credit, checking, savings, investment, lay-away, financing etc.) and the current and historical balances of such accounts, account activity etc. As exemplified by block 250, the second set of customer data may also include biographical data of the customer. Biographical data includes, but is not limited to, the age, sex, marital status, place of residence, current location, number of children, employment status etc. of a customer.

The second set of customer data is information that is available to a merchant based on prior interactions with the customer. For instance, a financial institution may have access to transactional, account history and biographical data of its customers by virtue of the accounts and financial services that customer utilizes through the financial institution. Retailers may have access to similar information through past purchases made by the customer through the retailer's stores. Other merchants may have direct access to similar information or it may be available to them through relationships the merchant has with other entities, such as financial institutions, marketing companies etc.

The first set of customer data may be collected in a number of different ways. Some social networking data can inferred from other customer data (i.e. the second set of customer data). For instance, the transactional data available to the merchant may illustrate the businesses connections within the customer's social network based on frequent transactions with the business. Similarly the transactional data and/or the account history data may demonstrate recurring deposits from a company representing an employer connection. Biographical data may identify the customer's family connections. Collecting social network data may also involve the business, merchant, financial institution etc. associating itself with the customer on an already-existing social network, such as Facebook®, wherein the business may receive access to additional information regarding the customer's social network data. Additionally, a customer may provide the business, merchant, financial institution etc. access to the customer's e-mail or other electronic communications, or some portion thereof (e.g. recipient's name, contents of the “re” line etc.) to identify those individuals or organizations with which the customer regularly corresponds or interacts. Furthermore, a merchant may independently create a unique social network and invite the customer to join the network and to bring his or her connections and thereby have access to the customer's social network data by virtue of hosting the social network. As illustrated by the remainder of the process flow 200, the first and second sets of customer data are analyzed to correlate the data to indicators of increased risk 130.

The first and second set of customer data may independently or jointly correlate to indicators of increased risk. For instance, the second set of customer data alone may reflect indicators of increased risk. Take for example a financial institution that has access to biographical information 250 of its customer indicating that the customer is a twenty year old male. The customer's account history data 240 indicates the customer has had a checking account with the financial institution for a number of years and for the past two years there has been a recurring bi-weekly deposit being made from the same company to the customer's account (suggesting a steady income). However, within the past two months the recurring deposit has stopped and the customer's transactional data 230 shows an increased reliance on credit and the account history data 240 indicates that the customer has missed consecutive payments on his credit accounts. This data alone may indicate to the financial institution that the customer is presently an increased financial risk.

In other instances the first and second set of data must be combined to correlate to indicators of increased risk. For example, a financial institution that by virtue of its relationship with its customer has access to data regarding the customer's income, mortgage payment and savings. This data considered alone indicates that the customer does not demonstrate any indicators of increased risk. However, the first set of customer data indicates that a number of the customer's neighbors, many of whom are within the customer's social network, have stopped making their mortgage payments despite appearing to be in a financial position to continue to make those payments (e.g. neighbor's updates discuss the default but social network page also includes photos from international vacation and shopping trip). Moreover, according the customer's Twitter® feed the customer recently received a tweet from one of his neighbors including a link to an article discussing the practice of strategic default. This data, when combined with information taken from the biographical information 250 available to the financial institution, indicating the customer lives in a neighborhood where the housing values have depreciated significantly, may indicate that the customer is at an increased risk of defaulting on his mortgage. By way of another example, a financial institution or merchant may determine from monitoring social network data that a customer's connections have recently shifted their purchasing practices. For instances, the customer's connections may previously have discussed or linked to articles discussing organic produce from a local organic grocer or purchasing coffee from a specialty retailer but more recently have been discussing sales and coupons from a discount grocery chain. If the customer's transaction data 230 (or other customer data) indicates a similar shift in the customer's shopping behavior, that is the customer also previously shopped at an organic grocer but then begins shopping at a discount grocery chain, this may be indicative that the customer is either starting to experience financial stress or anticipates future financial stress and may be a greater risk than is indicated by the customer data alone.

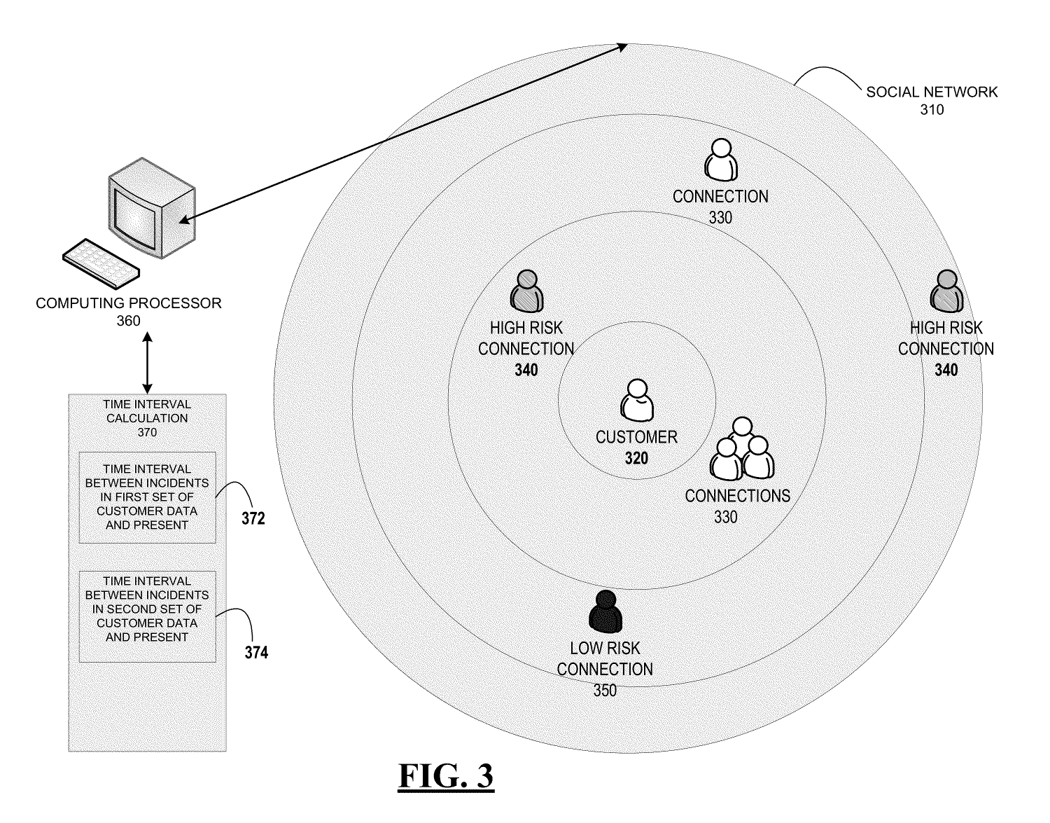

Referring now to FIGS. 1 and 3, after the first and second set of customer data is collected 110 120, the data is analyzed to correlate the data to indicators of increased risk 130. FIG. 3 illustrates a mixed block and flow diagram illustrating an apparatus for analyzing collected customer data, in accordance with embodiments of the invention, comprising a social network 310, a customer 320 and the customer's connections 330, some of which are high risk connections 340 and some of which are low risk connections 350. In some embodiments of the invention, the first set of customer data is analyzed to create a hierarchy of influence wherein the levels of connection between two or more of the connections in the customer's social network are compared and connections in the customer's social network with a conspicuous risk profile are identified. In the embodiment illustrated in FIG. 3, a computing processor 360 collects information from the customer's social network 310, consistent with the process flow illustrated in FIGS. 1 and 2 and described herein. The computing processor 360 identifies the customer's connections 330 and places the connections in a hierarchy of influence based on the connections' 330 relationship with the customer 320. As defined herein, a customer's social network 310 may include a wide variety of individuals and/or organizations ranging from the customer's closest friend to an individual with which the customer 320 has little to no personal interaction, such as a person who works in a different department of the same company as the individual. The customer's best friend may be more likely to be similar to the customer 320 (in circumstance, life position, experience, world-view etc.) than a little known work colleague. Moreover, the best friend's views and behaviors may be more likely to influence the behaviors of the customer 320 then someone not as close to the customer 320. The hierarchy of influence is illustrated by the concentric circles in FIG. 3, with the inner circles representing a higher degree of connection with the customer 320 and consequently, a higher likelihood of being similar to and/or influencing the customer 320 and the outer circles representing a lesser degree of connection with the customer 320.

The levels of connection between two or more of the connections and the customer can be determined in any manner suitable for the purpose. For instance, and without limitation, the levels of connection may be determined through self-identification, i.e. both parties indicate they are siblings, a photograph from a family reunion is uploaded to a social network and the caption identifies both parties as members of the family, the customer identifies a connection as his or her best friend etc. The levels of connection may also be determined through the frequency of traffic between the customer and connection over the social network. For example, if the customer sends direct communications to a connection more frequently than she does other connections within the social network it may be because the customer has a higher level of connection with the individual. Similarly if the customer interacts directly with the posts or information uploaded by the connection to a social network more often than he does with other connections it may be indicative of a higher degree of connection. Moreover, in some embodiments the levels of connection may be determined from an analysis of similarities between the customer and the connections. For instance, and without limitation, data available to the merchant or financial institution, as well as social network data can be analyzed to determine if the customer and a connection have similar patterns of behavior, such as shopping patterns (e.g. they frequent the same stores with similar regularity etc.). If the customer and one or more connection share a high degree of similarities in their behavior, the level of connection may be higher, that is the connection may be better able to influence the customer than is otherwise indicated by the amount of direct interaction between the customer and the connection.

In some such embodiments, the computing processor 360 also identifies those connections 330 with a conspicuous risk profile. A connection with a conspicuous risk profile can be either a high risk connection 340 wherein the connection's behaviors relate to increased risks, or a low risk connection 350 wherein the connection's behaviors relate to decreased risks. A high risk connection 340 with a high degree of influence may indicate that the customer 320 is an increased risk. For instance, if a close family member has previously been convicted of fraud or money laundering, this may indicate that the customer is an increased risk for similar actions. Conversely, a low risk connection 350 with a high degree of influence may indicate that the customer 320 is less of a risk. A high risk connection 340 that is not closely connected to the customer 320 may have little, to no, effect on the customer's risk profile. The same is true for a low risk connection 350 that is not closely connected to the customer. For example, if a customer's family members (with whom the customer interacts regularly) all have high, well established credit scores, it may indicate that the customer is less of a credit risk. Comparatively, if the customer's college roommate, who lives across the country and who rarely communicates or interacts with the customer defaults on an auto loan, this data may have little influence on whether the customer is also likely to default on a similar loan.

Still referencing FIG. 3, in some embodiments of the invention, analysis of the first and second set of data will involve gauging the time interval between incidents in the two sets of customer data and the present. This is illustrated by the process flow 370. The computing processor 360 analyzes incidents identified in the social network data and determines the amount of time that has passed since a given incident has occurred, 372. For instance, if a customer posted on a friend's blog that she had recently invested all of her life's savings into a new business and may have trouble making meeting all of her financial obligations for a while, such a posting may be relevant a week later as to whether the customer is likely to be able to meet the payment terms of a two year contract for cell phone and data service. However, if the post is six years old, it may no longer be relevant to the customer's current risk profile. Similarly, the computing processor 360 analyzes incidents identified in the second set of customer data to determine the amount of time that has passed, 374. In the same way that old social networking data is less relevant to a customer's current risk profile, so too older transactional, account history or biographical data may not be indicative of the customer's current risk profile. For instance, failure to pay a retailer's credit card when the customer was eighteen years old may not reflect an increased credit risk when the customer is forty.

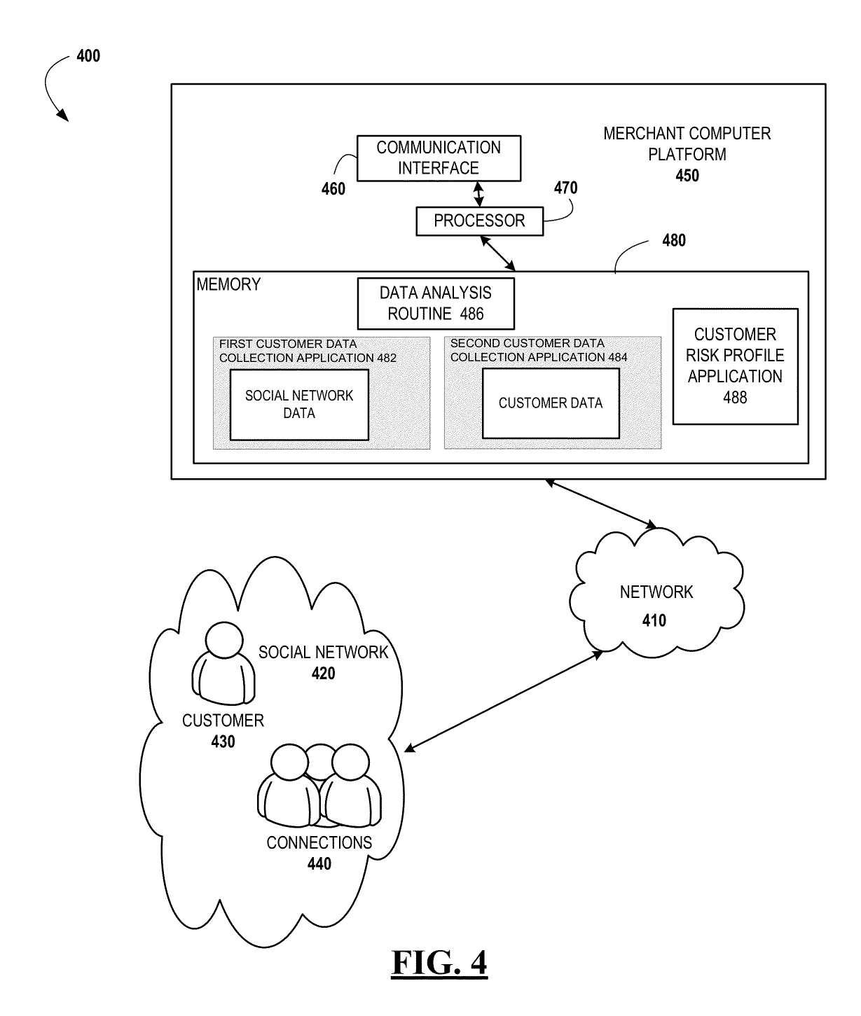

It will be understood that the method for determining a customer's risk profile as illustrated by the process flows 100 and 200 of FIGS. 1 and 2 and the mixed block and flow diagram of FIG. 3 can be embodied in a number of different apparatuses and systems. FIG. 4. provides a block diagram illustrating the technical components of such a system 400, in accordance with an embodiment of the present invention. As illustrated, the system 400 includes a network 410, a social network 420 and a merchant computer platform 450.

The merchant computer platform 450 may include any computerized apparatus that can be configured to perform any one or more of the functions of the invention described herein. In accordance with some embodiments, for example, the merchant computer platform 450 may include an engine, a platform, a server, a database system, a front end system, a back end system, a personal computer system, and/or the like. In some embodiments, such as the one illustrated in FIG. 4, the merchant computer platform 450 includes a communication interface 460 a processor 470 and a memory 480. The communication interface 460 is operatively and selectively connected to the processor 470, which is operatively and selectively connected to the memory 480.

The communication interface 460, generally includes hardware, and, in some instances, software, that enables the merchant computer platform 450 to transport, send, receive, and/or otherwise communicate information to or from other communication interfaces. For example, the communication interface 460, may include a modem, server, electrical connection and/or other electronic devices that operatively connect the merchant computer platform 450 to another electronic device.

The processor 470 generally includes circuitry or executable code for implementing the audio, visual, and/or logic functions of the merchant computer platform 450. For example, the processor may include a digital signal processor device, a microprocessor device, and various analog-to-digital converters, digital-to-analog converters, and other support devices. Control and signal processing functions of the system in which the processor resides may be allocated between these devices according to their respective capabilities. The processor 470 may also include functionality to operate one or more software programs based at least partially on computer-executable program code portions thereof, which may be stored, for example, in a memory device, such as the memory 480 of the merchant computer platform 450.

The memory 480, may include any computer-readable medium. For example, memory may include volatile memory, such as volatile random access memory (RAM) having a cache area for the temporary storage of data. Memory 480 may also include non-volatile memory, which may be embedded and/or may be removable. The non-volatile memory may additionally or alternatively include an EEPROM, flash memory, and/or the like. The memory 480 may store any one or more pieces of information and data used by the merchant computer platform 450 to implement the functions of the merchant computer platform 450.

It will be understood that the merchant computer platform 450 can be configured to implement one or more portions of the process flows described and/or contemplated herein. For example, as illustrated in FIG. 4, a first customer data collection application 482 may be stored in the memory 480, executable by the processor 470 and configured to collect a first set of customer data from social networks in which the customer is a member, wherein the first set of customer data is indicative of the customer's risk tendencies. A second customer data collection application 484 may also be stored in the memory 480, executable by the processor 470 and configured to collect a second set of customer data, wherein the second set of customer data comprises data available to a merchant based on the prior interactions between the merchant and the customer. The first and second sets of customer data collected by the first customer data collection application 482 and the second customer data collection application 484 may be stored in the memory 480 for analysis by the data analysis routine 486 or the data may be dynamically analyzed by the processor 470 without being stored in the memory 480. A data analysis routine 484 is also provided, stored in the memory 480, executable by the processor 470 and configured to correlate said first set of customer data and second set of customer data to indicators of increased risk. A customer risk profile application 488 may also be stored in the memory 480, executable by the processor 470 and configured to determine a customer risk profile based on the indicators of increased risk

As shown in FIG. 4, the social network 420 and merchant computer platform 450 are each operatively and selectively connected to the network 410, which may include one or more separate networks. In addition, the network 410, may include a local area network (LAN), a wide area network (WAN), and/or a global area network (GAN), such as the Internet. It will also be understood that the network 410 may be secure and/or unsecure and may also include wireless and/or wireline technology.

It will be understood that the merchant computer platform in performing one or more portions of the process flows described and/or contemplated herein will operatively connect to the network 410 through the communication interface 460 to receive data from the customer 430 or connections 440 within the social network 420. For instance, in collecting social network data that relates to the customer's risk tendencies (as illustrated in FIG. 2, blocks 110, 210 and 220), the merchant computer platform 450 may access the social network 420 over the network 410 to identify the connections 440 in the customer's 430 social network 420 to determine the customer's social network position 210 and/or collect expressed data 220 that relates to the customer's risk tendencies (e.g. comments, photos or posts concerning the customer's raise and promotion at work etc.). Similarly, in creating a hierarchy of influence, and identifying connections with a conspicuous risk profile (as illustrated in FIG. 3), the merchant computer platform 450 may access the social network 420 by using the communication interface 460 to operatively connect to the network 410 and the social network 420 so that the processor 470 may execute the data analysis routine 486 to identify the levels of connection between the connections 440 and the customer 430 and identify information regarding the risk profile of the connection 440.

By way of example, and without expressing any limitation on the function of the methods, systems and apparatuses described and/or contemplated herein, in use, a merchant, such as a financial institution, may determine a customer's risk profile for use in consideration with, for example a decision to increase the customer's credit line, by collecting data, such as the transactional data (e.g. frugal purchases relative to income, consistent contributions to savings etc.) 230, account history data (e.g. reasonable amount of debt burden, minimum payments to accounts made monthly etc.) 240, and biographical data (e.g. middle aged, married etc.) 250 available to the financial institution using the second customer data collection application 484 of the merchant computer platform 450. From its analysis of this data 130, the financial institution may conclude that the customer does not demonstrate indicators of being an increased risk and determine that the customer has a low risk profile. Concurrently, the financial institution may collect data from the customer's social network using the first customer data collection application 482 of the merchant computer platform 450. The social network data may indicate that all of the customer's connections who are work colleagues are recently unemployed indicating that the customer's employer may be in the midst of extensive layoffs and conclude the customer's risk profile should be increased. Combining the indicators of increased risk identified by the data analysis routine 486 relative to both data sets may ultimately lead the financial institution to only approve a marginal increase to the customer's credit line whereas if it had only considered the information from the second set of customer data, the credit line increase may have been more substantial.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for determining a customer's risk profile, comprising:
collecting, via a computing processor, a first set of customer data from social networks in which the customer is a member, wherein said first set of customer data is indicative of the customer's risk tendencies;
collecting, via the computing processor, a second set of customer data, wherein the second set of customer data comprises data available to a merchant based on prior interactions between the merchant and the customer;
determining, via the computing processor, a hierarchy of influence for the customer's social network connections, wherein the hierarchy of influence is determined by analyzing similarities between the second set of customer data for the customer and data available to a merchant based on prior interactions between the merchant and the customer's social network connections;
analyzing, via the computing processor, said first set of customer data and said second set of customer data in order to correlate said first set of customer data and second set of customer data to indicators of increased risk; and
determining a customer risk profile based on the indicators of increased risk and the hierarchy of influence.

2. The method of claim 1 wherein the first set of customer data comprises the customer's social network position.

3. The method of claim 1 wherein the second set of customer data comprises transactional data.

4. The method of claim 1 wherein the second set of customer data comprises account history data.

5. The method of claim 1 wherein the second set of customer data comprises biographical data.

6. (canceled)

7. The method of claim 1 wherein analyzing said first set of customer data comprises gauging an interval of time between incidents within the first set of customer data and a current time.

8. The method of claim 1 wherein analyzing said second set of customer data comprises gauging an interval of time between incidents within the second set of customer data and a current time.

9. The method of claim 1, further comprising using the customer's risk profile in the decision to offer products or services to the customer.

10. The method of claim 1 wherein the risk is the customer's risk of defaulting on financial obligations.

11. An apparatus for determining a customer's risk profile, the apparatus comprising:
a computing platform including a memory and at least one processor;
a first customer data collection application stored in the memory, executable by the processor and configured to collect a first set of customer data from social networks in which the customer is a participant, wherein said first set of customer data is indicative of the customer's risk tendencies;
a second customer data collection application stored in the memory, executable by the processor and configured to collect a second set of customer data, wherein the second set of customer data comprises data available to a merchant based on prior interactions between the merchant and the customer;
a network analysis routine stored in the memory, executable by the processor, and configured to determine a hierarchy of influence for the customer's social network connections, wherein the hierarchy of influence is determined by analyzing similarities between the second set of customer data for the customer and data available to a merchant based on prior interactions between the merchant and the customer's social network connections;
a data analysis routine stored in the memory, executable by the processor and configured to analyze said first set of customer data and said second set of customer data in order to correlate said first set of customer data and second set of customer data to indicators of increased risk; and
a customer risk profile application stored in the memory, executable by the processor, configured to determine a customer risk profile based on the indicators of increased risk and the hierarchy of influence.

12. The apparatus of claim 11, wherein the first set of customer data comprises the customer's social network position.

13. The apparatus of claim 11, wherein the second set of customer data comprises transactional data.

14. The apparatus of claim 11, wherein the second set of customer data comprises account history data.

15. The apparatus of claim 11, wherein the second set of customer data comprises biographical data.

16. (canceled)

17. The apparatus of claim 11, wherein the data analysis routine is configured to gauge an interval of time between incidents within the first set of customer data and a current time.

18. The apparatus of claim 11, wherein the data analysis routine is configured to gauge an interval of time between incidents within the second set of customer data and a current time.

19. The apparatus of claim 11, further comprising a decision application stored in the memory, executable by the processor, configured to use the customer's risk profile in the decision to offer products or services to the customer.

20. The apparatus of claim 11, wherein the risk is the customer's risk of defaulting on financial obligations.

21. A computer program product comprising:
a non-transitory computer-readable medium comprising,
a first set of code for causing a computer to collect a first set of customer data from social networks in which the customer is a member, wherein said first set of customer data is indicative of the customer's risk tendencies;
a second set of code for causing a computer to collect a second set of customer data, wherein the second set of customer data comprises data available to a merchant based on prior interactions between the merchant and the customer;
a set of codes for determining a hierarchy of influence for the customer's social network connections, wherein the hierarchy of influence is determined by analyzing similarities between the second set of customer data for the customer and data available to a merchant based on prior interactions between the merchant and the customer's social network connections;
a third set of code for causing a computer to analyze said first set of customer data and said second set of customer data in order to correlate said first set of customer data and second set of customer data to indicators of increased risk; and
a fourth set of code for causing a computer to determine a customer risk profile based on the indicators of increased risk and the hierarchy of influence.

22. The computer program product of claim 21, wherein the first set of code collects data relating to the customer's social network position.

23. The computer program product of claim 21, wherein the second set of code collects the customer's transactional data.

24. The computer program product of claim 21, wherein the second set of code collects the customer's account history data.

25. The computer program product of claim 21, wherein the second set of code collects the customer's biographical data.

26. (canceled)

27. The computer program product of claim 21, wherein the third set of code causes a computer to gauge an interval of time between incidents within the first set of customer data and a current time.

28. The computer program product of claim 21, wherein the third set of code causes a computer to gauge an interval of time between incidents within the second set of customer data and a current time.

29. The computer program product of claim 21, further comprising a fifth set of code for causing a computer to use the customer risk profile in deciding whether to offer products or services to the customer.

30. The computer program product of claim 21, wherein the risk is the customer's risk of defaulting on financial obligations.
